(19) United States
(12) Patent Application Publication
(10) Pub. No.: US 2013/0246817 A1
(43) Pub. Date: Sep. 19, 2013

(54) BATTERY REPLACING SYSTEM AND METHOD THEREOF

(71) Applicant: HON HAI PRECISION INDUSTRY CO., LTD., Tu-Cheng (TW)

(72) Inventor: TSUI-MING YANG, Tu-Cheng (TW)

(73) Assignee: HON HAI PRECISION INDUSTRY CO., LTD., Tu-Cheng (TW)

(21) Appl. No.: 13/626,999

(22) Filed: Sep. 26, 2012

(30) Foreign Application Priority Data
Mar. 16, 2012 (TW) 101109045

(51) Int. Cl. G06F 1/26; G06F 1/32

(52) U.S. Cl. 713/320; 713/300

(57) ABSTRACT

A battery replacing system for replacing a battery of an electronic device, includes a power storage unit and a switch circuit. The power storage unit can be charged by the battery when the battery is mounted to the electronic device. The switch circuit alternatively connects one of the power storage unit or the battery to an operating system of the electronic device. The switch connects the power storage unit to the operating system to have the power storage unit provide power to the operating system when the battery is detached from the electronic device, and connect the battery to the operating system to have the battery provide power to the operating system when the battery is mounted to the electronic device.

### BACKGROUND

1. Technical Field

The present disclosure relates to a battery replacing system and a method thereof.

2. Description of Related Art

Many electronic devices, such as cellular phones, laptop computers, and tablet computers, in addition to original batteries to provide power to the electronic devices, are also supplied with backup batteries. Although a backup battery is useful to replace the original battery when the original battery is not sufficiently charged, the electronic device needs to be shut off to switch between the original and the backup batteries, which can be very inconvenient.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a battery replacing system according to an embodiment.

FIG. 2 is a flow chart of a battery replacing method according to an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

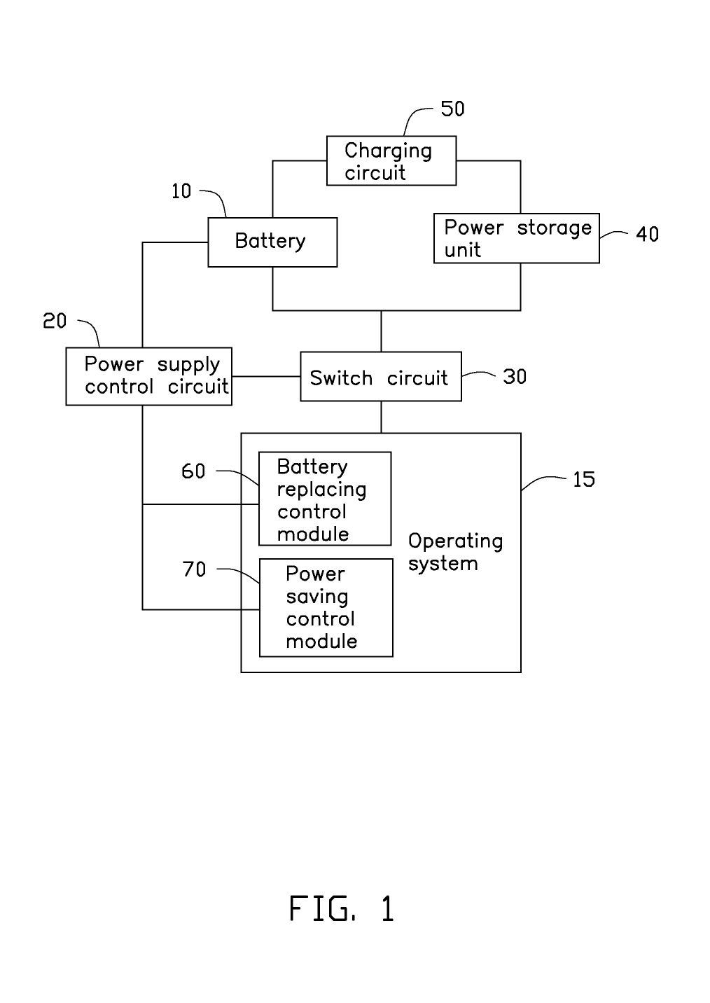

FIG. 1 shows a battery replacing system according to an embodiment. The battery replacing system is used to change out a battery of an electronic device. The electronic device includes a battery 10.

The battery replacing system includes a power supply control circuit 20, a switch circuit 30, a power storage unit 40, a charging circuit 50, a battery replacing control module 60, and a power saving control module 70. The battery replacing control module 60 and the power saving control module 70 are installed in an operating system 15 of the electronic device. The battery replacing control module 60 and the power saving control module 70 are connected to the power supply control circuit 20. The power supply control circuit 20 is connected to the switch circuit 30. The battery 10 and the power storage unit 40 can provide power to the operating system 15 of the electronic device via the switch circuit 30. The battery 10 is connected to the power storage unit 40 via the charging unit 50. The battery 10 can charge the power storage unit 40 according to the charging unit 50. The power supply control circuit 20 is connected to the battery 10 when the battery 10 is mounted to the electronic device, and can detect when the battery 10 is mounted to the electronic device.

The power storage unit 40 is configured to supply power to the operating system 15 during times no battery 10 is not mounted to the electronic device. In one embodiment, the power storage unit 40 is a super capacitor.

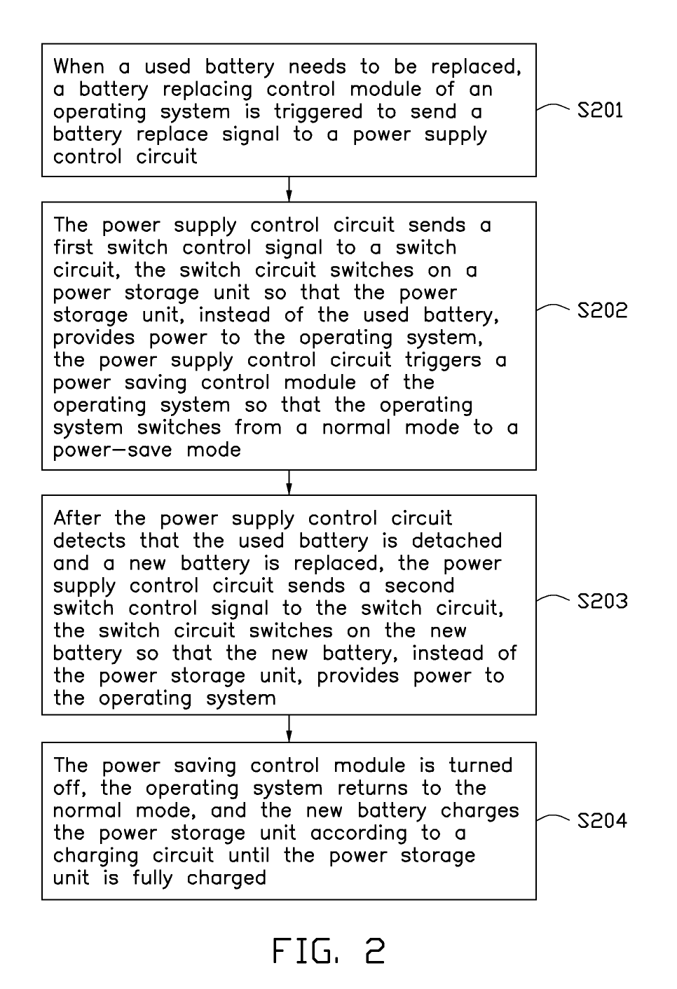

FIG. 2 shows an embodiment of a flow chart of a battery replacing method, which includes following steps:

In step S201, after an old battery 10 is used for a long time and needs to be replaced, the battery replacing control module 60 is triggered to send a battery replace signal to the power supply control circuit 20.

In step S202, the power supply control circuit 20 sends a first switch control signal to the switch circuit 30, the switch circuit 30 switches to the power storage unit 40, the power storage unit 40 instead of the old battery 10 provides power to the operating system 15, the power supply control circuit 20 triggers the power saving control module, and the operating system 15 switches from a normal mode to a power-save mode, in which peripheral devices of the electronic device are shut off and a screen of the electronic device turns dark.

In step S203, after the power supply control circuit 20 detects that the old battery 10 is detached from the electronic device and a new battery 10 is mounted on the electronic device, the power supply control circuit 20 sends a second switch control signal to the switch circuit 30. The switch circuit 30 switches to the new battery 10, and the new battery 10 instead of the power storage unit 40 provides power to the operating system 15.

In step S204, the power saving control module 70 is turned off, the operating system 15 returns back to the normal mode, and the new battery 10 charges the power storage unit 40 according to the charging circuit 50 until the power storage unit 40 is full.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A battery replacing system for replacing a battery of an electronic device, comprising:
a power storage unit adapted to be charged by a battery attached to an electronic device; and
a switch circuit connecting either the power storage unit or the battery to an operating system of the electronic device; wherein when the battery is detached from the electronic device, the switch circuit connects the power storage unit to the operating system so that the power storage unit provides power to the operating system; and when the battery is attached to the electronic device, the switch connects the battery to the operating system so that the battery provides power to the operating system.

2. The battery replacing system of claim 1, wherein a charging circuit is connected between the battery and the power storage unit, and the battery charges the power storage unit via the charging circuit when the battery is attached to the electronic device.

3. The battery replacing system of claim 1, comprising a power supply control circuit configured to detect whether the battery is attached to the electronic device.

4. The battery replacing system of claim 3, wherein the power supply control circuit is connected to the switch circuit, and the power supply control circuit is configured to control the switch circuit.

5. The battery replacing system of claim 4, wherein the power supply control circuit is connected to a battery replacing control module, and the battery replacing control module is configured to be trigged to send a battery replace signal to the power supply control circuit, and the power supply control circuit is further configured to control the switch circuit to connect the power storage unit to the operating system when the power supply control circuit receives the battery replace signal.

6. The battery replacing system of claim 5, wherein the power supply control circuit is further configured to control the switch circuit to connect the battery to the operating system when the power supply control circuit detects that the battery is attached to the electronic device.

7. The battery replacing system of claim 5, wherein the power supply control circuit is connected to a power saving control module, and the power saving control module is configured to turn the operating system from a normal mode into a power-save mode when the power supply control circuit receives the battery replace signal.

8. The battery replacing system of claim 7, wherein in the power-save mode, peripheral devices of the electronic device are shut off and a screen of the electronic device turns dark.

9. A battery replacing method, comprising:
when an used battery of an electronic device needs to be replaced, triggering an battery replacing control module to send a battery replace signal to a power supply control circuit;
controlling a power storage unit to provide power to the electronic device;
replacing the used battery with a new battery attached to the electronic device; and
controlling the new battery to provide power to the electronic device and controlling the power storage unit to stop providing power to the electronic device.

10. The battery replacing method of claim 9, comprising charging the power storage unit by the new battery charges unit until the power storage unit is fully charged after the new battery is attached to the electronic device.

11. The battery replacing method of claim 9, comprising causing the electronic device to switch from a normal mode to a power-save mode when the power storage unit provides power to the electronic device.

12. The battery replacing method of claim 11, further comprising causing peripheral devices of the electronic device to shut off and causing a screen of the electronic device to turn dark when the electronic device is in the power-save mode.

13. The battery replacing method of claim 11, further comprising causing the electronic device to return to the normal mode when new battery provides power to the electronic device.

14. The battery replacing method of claim 9, comprising connecting a charging circuit between the new battery and the power storage unit so that the power storage unit is charged by the new battery.
